(19) United States
(12) Patent Application Publication
(10) Pub. No.: US 2004/0075630 A1
(43) Pub. Date: Apr. 22, 2004

(54) Display panel having embedded test circuit

(76) Inventor: Chaung-Ming Chiu, Taoyuan (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/444,674

(22) Filed: May 23, 2003

(30) Foreign Application Priority Data
Oct. 22, 2002 (TW) 091124411

(51) Int. Cl. G09G 3/36

(52) U.S. Cl. 345/92

(57) ABSTRACT

A display panel includes a substrate, a pixel matrix, a driving circuit and an embedded test circuit. The pixel matrix is formed on the substrate. The driving circuit is formed on the substrate and electrically connected to the pixel matrix for controlling the pixel matrix in either a switching-on or switching-off state. The embedded test circuit is formed on the substrate and electrically connected to the driving circuit for testing the driving circuit and outputting a test result.

### FIELD OF THE INVENTION

The present invention relates to a display panel, and more particularly to a display panel having an embedded test circuit.

### BACKGROUND OF THE INVENTION

Liquid crystal displays (LCDs) are widely used in portable televisions, laptop personal computers, notebooks, electronic watches, calculators, mobile phones and office automation devices, etc. due to their advantages of small size, light weight, low driving voltage, low power consumption and good portability.

Please refer to FIG. 1. A typical liquid crystal display panel 1 principally comprises a pixel matrix 10, a horizontal scan circuit 11 and a vertical scan circuit 12. Since the sizes of the pixel matrix 10 are growing larger and larger, bilateral horizontal scan circuits 11 are required for providing a sufficient driving capacity. The pixel matrix 10 is generally implemented by a thin film transistor array, and driven by the scan circuits. The thin film transistor array comprises a plurality of scan lines, data lines and display cells. Via each scan line, all the display cells of the same row are controlled in either a switching-on or switching-off state. The data lines transmit video signals to the switched-on cells electrically connected thereto.

Driving signals are transmitted from a driving integrated circuit (driving IC) 13 via a plurality of signal lines or a flex cable 14 so as to drive the display panel 1. With the increasing development of fabricating TFTLCDs (Thin Film Transistor Liquid Crystal Displays), the horizontal scan circuit 11 and the vertical scan circuit 12 are incorporated into the display panel 1 in place of being as parts of the driving IC 13. In order to test these incorporated scan circuits, the display panel 1 further comprise a plurality of signal pins 15 to electrically connect these scan circuits to a test circuit (not shown) outside the display panel 1. With such configuration, the numbers of the signal pins are very critical. For example, if too many signal pins are used, the producing cost is increased. However, insufficient signal pins might be unfavorable to provide an accurate and/or speedy test.

### SUMMARY OF THE INVENTION

It is an object of the present invention to provide a display panel having reduced signal pins without adversely effecting on the testing quality of the display panel.

In accordance with a first aspect of the present invention, there is provided a display panel. The display panel includes a substrate, a pixel matrix, a driving circuit and an embedded test circuit. The pixel matrix is formed on the substrate. The driving circuit is formed on the substrate and electrically connected to the pixel matrix for controlling the pixel matrix in either a switching-on or switching-off state. The embedded test circuit is formed on the substrate and electrically connected to the driving circuit for testing the driving circuit and outputting a test result.

In an embodiment, the substrate is a transparent substrate.

In an embodiment, the pixel matrix includes a thin film transistor (TFT) array.

In an embodiment, the test result is outputted to an external device via a single signal pin. In another embodiment, the test result is outputted to an external device via a signal pin through which the driving circuit outputs a driving signal.

In an embodiment, the driving circuit comprises at least a horizontal scan circuit and at least a vertical scan circuit.

In an embodiment, the driving circuit comprises a driving logic circuit and a plurality of shift registers.

In an embodiment, the embedded test circuit comprises a combination logic circuit for performing a logic operation on signals received from the shift registers and the driving logic circuit to obtain the test result. Preferably, the combination logic circuit outputs a failed signal when any one of the shift registers and the driving logic circuit is not in a normal operation mode.

In an embodiment, the embedded test circuit comprises a combination logic circuit for performing a logic operation on signals asserted by the driving circuit to obtain the test result.

In accordance with a second aspect of the present invention, there is provided a display panel. The display panel includes a substrate, a pixel matrix, a driving circuit and a test circuit. The display panel includes a substrate, a pixel matrix, a driving circuit and an embedded test circuit. The pixel matrix is formed on the substrate. The driving circuit is formed on the substrate and electrically connected to the pixel matrix for controlling the pixel matrix in either a switching-on or switching-off state. The test circuit is formed on the substrate and electrically connected to the driving circuit for testing the driving circuit. In addition, the test circuit utilizes the output pin of the driving circuit to output a test result.

In an embodiment, the test circuit comprises a combination logic circuit for performing a logic operation on signals asserted by the driving circuit.

In an embodiment, the combination logic circuit performs a logic operation on signals received from a plurality of shift registers and a driving logic circuit of the driving circuit.

In an embodiment, the combination logic circuit outputs a failed signal when any one of the shift registers and the driving logic circuit is not in a normal operation mode.

In accordance with a third aspect of the present invention, there is provided a display panel. The display panel includes a substrate, a pixel matrix, a driving circuit and a test circuit. The pixel matrix is formed on the substrate. The driving circuit is formed on the substrate and electrically connected to the pixel matrix for controlling the pixel matrix in either a switching-on or switching-off state. The test circuit is formed on the substrate and electrically connected to the driving circuit for testing the driving circuit, and outputs a test result to an external device via a single signal pin.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit block diagram illustrating the configuration of a conventional liquid crystal display panel;

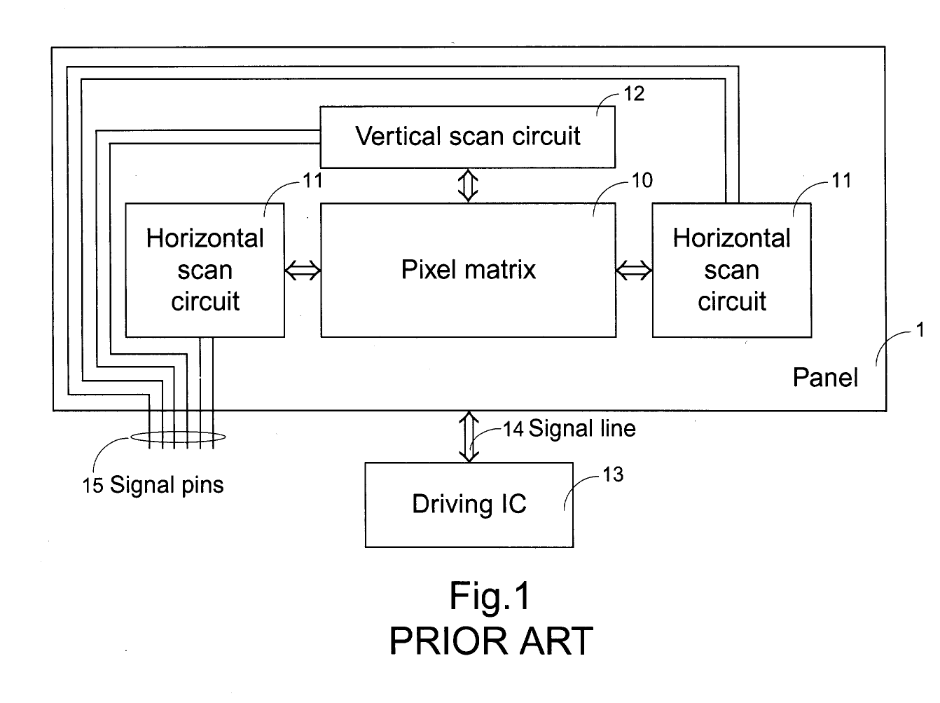

FIG. 2 is a schematic circuit block diagram illustrating the configuration of a liquid crystal display panel according to a preferred embodiment of the present invention; and

FIG. 3 is a functional block diagram illustrating an embedded test circuit for testing a driving circuit.

### DETAILED DESCRIPTION OF THE PREFERRED EMBODIMENT

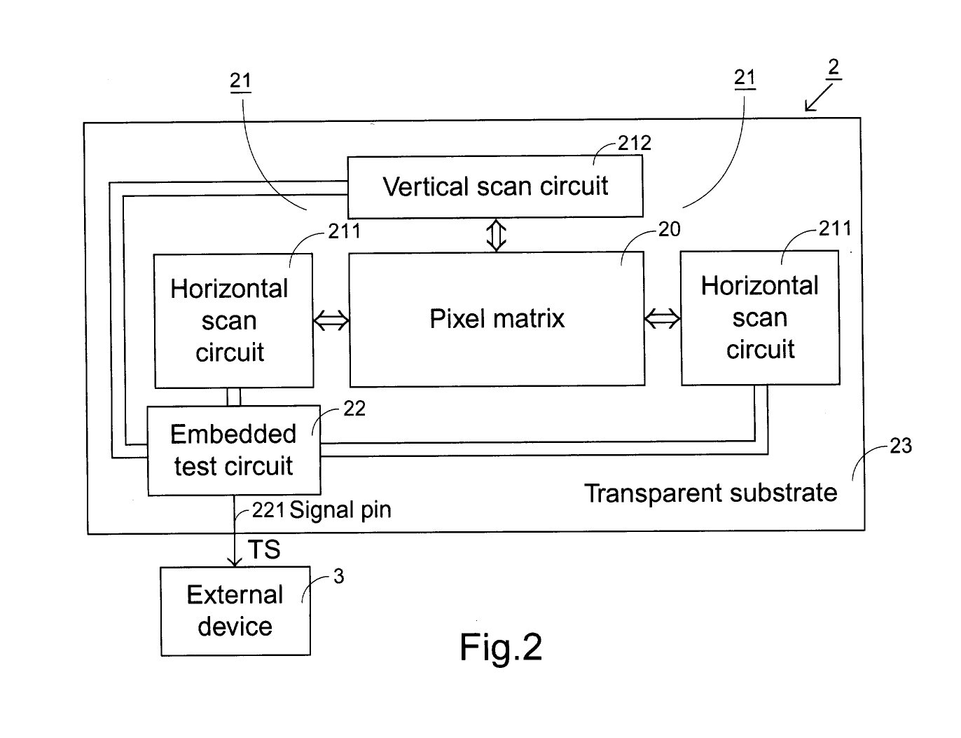

Please refer to FIG. 2, which illustrates a liquid crystal display panel according to a preferred embodiment of the present invention. The panel 2 comprises a pixel matrix 20, a driving circuit 21 and an embedded test circuit 22, formed on a transparent substrate 23. The driving circuit 21 comprises horizontal scan circuit 211 and vertical scan circuit 212. The pixel matrix 20 is implemented by a thin film transistor array in a TFTLCD, and driven by the scan circuits. The thin film transistor array comprises a plurality of scan lines, data lines and display cells (not shown). Via scan lines, the display cells of the same row are controlled in either a switched-on or switched-off state. The data lines transmit video signals to the switched-on cells electrically connected thereto. The embedded test circuit 22 is electrically connected to the driving circuit 21 for testing and indicating the status of the driving circuit 21 by outputting a test result TS.

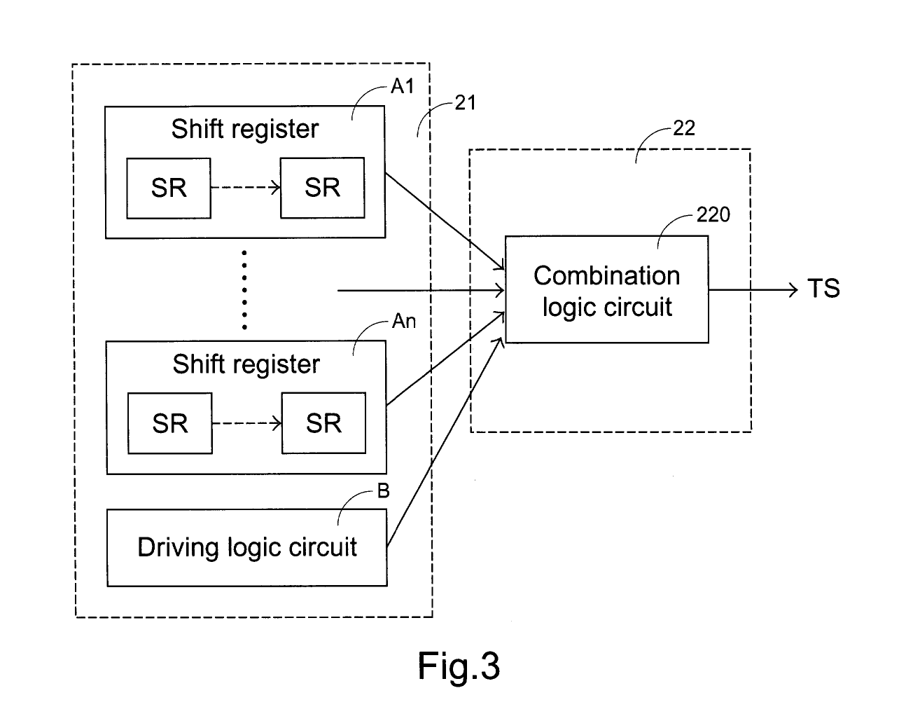

Referring to FIG. 3, the embedded test circuit 22 comprises a combination logic circuit 220 for performing a logic operation on signals received from a plurality of shift registers Al˜An and a driving logic circuit B of the driving circuit 21. The shift registers Al˜An and the driving logic circuit B start to perform a test procedure in response to a test signal, and output respective signals indicating normal/abnormal operation conditions to the combination logic circuit 220. The combination logic circuit 21 performs a logic operation on those signals to obtain the test result TS. When all the shift registers Al˜An and the driving logic circuit B are normally operated, the combination logic circuit 220 outputs a normal signal, for example logic “0”. On the contrary, when any one of the shift registers Al˜An and the driving logic circuit B is not in a normal operation mode, the combination logic circuit 220 outputs a failed signal, for example logic “1”. Accordingly, the user can conveniently and quickly realize the operating condition from the test result TS of the combination logic circuit 220.

Since the test circuit 22 and the driving circuit 21 to be tested are both incorporated in the transparent substrate 23, the connecting lines between the embedded test circuit 22 and the driving circuit 21 are formed on the transparent substrate 23 with almost no exposed signal pins. The only required signal pin 221 is for outputting the test result to an external device 3. Preferably, the embedded test circuit 22 shares the signal pin with the driving circuit 21, from which the driving signal is outputted. Alternatively, the single pin can be additionally and exclusively provided.

It is understood from the above description, the embedded circuit used in the present display panel has relatively reduced signal pins without adversely effecting on the testing quality of the display panel. In other words, an accurate and/or speedy test result can be obtained without increasing the producing cost of the display panel.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A display panel, comprising:
a substrate;
a pixel matrix formed on said substrate;
a driving circuit formed on said substrate and electrically connected to said pixel matrix for controlling said pixel matrix in either a switching-on or switching-off state; and
an embedded test circuit formed on said substrate and electrically connected to said driving circuit for testing said driving circuit and outputting a test result.

2. The display panel according to claim 1 wherein said substrate is a transparent substrate.

3. The display panel according to claim 1 wherein said pixel matrix includes a thin film transistor (TFT) array.

4. The display panel according to claim 1 wherein said test result is outputted to an external device via a single signal pin.

5. The display panel according to claim 1 wherein said test result is outputted to an external device via a signal pin through which said driving circuit outputs a driving signal.

6. The display panel according to claim 1 wherein said driving circuit comprises at least a horizontal scan circuit and at least a vertical scan circuit.

7. The display panel according to claim 1 wherein said driving circuit comprises a driving logic circuit and a plurality of shift registers.

8. The display panel according to claim 7 wherein said embedded test circuit comprises a combination logic circuit for performing a logic operation on signals received from said shift registers and said driving logic circuit to obtain said test result.

9. The display panel according to claim 8 wherein said combination logic circuit outputs a failed signal when any one of said shift registers and said driving logic circuit is not in a normal operation mode.

10. The display panel according to claim 1 wherein said embedded test circuit comprises a combination logic circuit for performing a logic operation on signals asserted by said driving circuit to obtain said test result.

11. A display panel, comprising:
a substrate;
a pixel matrix formed on said substrate;
a driving circuit formed on said substrate and electrically connected to said pixel matrix for controlling said pixel matrix in either a switching-on or switching-off state; and
a test circuit formed on said substrate, electrically connected to said driving circuit for testing said driving circuit, and utilizing the output pin of said driving circuit to output a test result.

12. The display panel according to claim 11 wherein said test circuit comprises a combination logic circuit for performing a logic operation on signals asserted by said driving circuit.

13. The display panel according to claim 12 wherein said combination logic circuit performs a logic operation on signals received from a plurality of shift registers and a driving logic circuit of said driving circuit.

14. The display panel according to claim 13 wherein said combination logic circuit outputs a failed signal when any one of said shift registers and said driving logic circuit is not in a normal operation mode.

15. A display panel, comprising:
a substrate;
a pixel matrix formed on said substrate;
a driving circuit electrically connected to said pixel matrix for controlling said pixel matrix in either a switching-on or switching-off state; and
a test circuit formed on said substrate, electrically connected to said driving circuit for testing said driving circuit, and outputting a test result to an external device via a single signal pin.

16. The display panel according to claim 15 wherein said test circuit comprises a combination logic circuit for performing a logic operation on signals asserted by said driving circuit.

17. The display panel according to claim 16 wherein said combination logic circuit performs a logic operation on signals received from a plurality of shift registers and a driving logic circuit of said driving circuit.

18. The display panel according to claim 17 wherein said combination logic circuit outputs a failed signal when any one of said shift registers and said driving logic circuit is not in a normal operation mode.
